(19) United States
(12) Patent Application Publication
(10) Pub. No.: US 2024/0409120 A1
(43) Pub. Date: Dec. 12, 2024

(54) CONTROL DEVICE FOR AUTONOMOUS DRIVING VEHICLE

(71) Applicant: TOYOTA JIDOSHA KABUSHIKI KAISHA, Toyota-shi (JP)

(72) Inventors: Yushi SHIBAIKE, Susono-shi (JP); Go INOUE, Gotemba-shi (JP); Yutaka AOKI, Mishima-shi (JP); Yushi NAGATA, Atsugi-shi (JP); Shogo TAKAHIRA, Shizuoka-ken (JP); Takahiro KOJO, Gotemba-shi (JP); Yoji KUNIHIRO, Susono-shi (JP); Hiroki SHIZUHATA, Toyota-shi (JP)

(73) Assignee: TOYOTA JIDOSHA KABUSHIKI KAISHA, Toyota-shi (JP)

(21) Appl. No.: 18/654,362

(22) Filed: May 3, 2024

(30) Foreign Application Priority Data
Jun. 12, 2023 (JP) 2023-096129

(51) Int. Cl. B60W 60/00; B60W 40/10; B60W 50/00

(52) U.S. Cl. CPC B60W 60/001; B60W 40/10; B60W 50/00; B60W 2050/0012; B60W 2552/30; B60W 2556/40; B60W 2710/207

(57) ABSTRACT

A control device for causing a vehicle to travel by autonomous driving based on a target path calculated based on a current position on map data of a vehicle estimated by a map data, a behavior detection sensor, and an external detection sensor, wherein a current position of the vehicle is estimated by correcting a position on map data of the vehicle in accordance with a relative position of the vehicle on a roadway, a correction amount at that time is obtained, a change in a correction amount is predicted by map data and an external detection sensor, and a control gain in a control input when the vehicle is caused to travel by autonomous driving is changed in accordance with the change, thereby changing a characteristic of the traveling control.

### CROSS-REFERENCE TO RELATED APPLICATION

This application claims priority to Japanese Patent Application No. 2023-096129 filed on Jun. 12, 2023, incorporated herein by reference in its entirety.

### BACKGROUND

### 1. Technical Field

The disclosure relates to a control device for a vehicle capable of traveling by autonomous driving, based on behavior of the vehicle recognized by a sensor or the like, and information that is externally acquired.

### 2. Description of Related Art

Japanese Unexamined Patent Application Publication No. 2019-207190 (JP 2019-207190 A) discloses an own position estimation device for the purpose of stabilizing estimation accuracy of the own position even when the vehicle travels in a section where the number of lanes changes. The own position estimation device according to JP 2019-207190 A estimates a position of the own vehicle based on image data obtained by an in-vehicle camera, data of state quantity of the own vehicle acquired from a sensor or the like, GPS data, and map data. In the own position estimation device according to JP 2019-207190 A, a configuration is made such that when recognizing a no-lane section, which is a section in which the number of lanes increases or decreases, based on the image data, use of the map data is restricted as compared with when there is no recognition of a no-lane section, i.e., weighting of the map data is reduced to correct an estimated position of the own vehicle. JP 2019-207190 A states that such a configuration enables deterioration in estimation precision of the own position to be suppressed in no-lane sections where link data of the road is not accurately created, and thus the accuracy of own position estimation can be stabilized.

### SUMMARY

When identifying the position of the vehicle, each component of a longitudinal direction (front-rear direction), a lateral direction (right-left direction), and a yaw direction (or azimuth angle) is identified. That is to say, for each component, the position of the vehicle estimated based on the state quantity of the vehicle, the map data, and so forth, and the position of the vehicle on an actual roadway that is actually measured by the camera or the like, are acquired at predetermined cycles, and the position of the vehicle on the map data is estimated by performing matching thereof, as in the device according to JP 2019-207190 A. The vehicle is controlled to assist the vehicle to travel along the target path from the position of the vehicle that is estimated. There are cases in which a configuration is made such that, when the position of the vehicle is estimated by correcting the position of the vehicle estimated in this way, based on the actually-measured position of the vehicle, weighting data is changed in accordance with each component.

For example, there are cases in which a configuration is made such that, when the position of the vehicle in the lateral direction is estimated, information recognized by the camera installed in the vehicle is weighted, and a configuration is made such that, when the position of the vehicle in the yaw direction is estimated, information regarding behavior of the vehicle detected by various types of sensors and the like provided in the vehicle is weighted. In such cases, for example, when there is a deviation between the map data and the actual roadway, there is a possibility that the recognition of difference regarding the actual vehicle position from a center position of the roadway and the target position thereof may be different in each component.

Specifically, since information recognized by the camera is weighted with respect to the lateral direction, occurrence of such a difference is detected at a relatively early stage. On the other hand, in the yaw direction, when such a difference occurs, information based on the behavior of the vehicle is weighted. Thus, with regard to the yaw direction, there is a possibility that the above-described difference will detected as being small, due to error and so forth in map data and data related to the behavior of the vehicle. That is to say, there is a possibility that the deviation of the vehicle from the center position or the target position on the roadway is detected relatively correctly in the lateral direction, whereas this deviation cannot be detected correctly in the yaw direction. When changing the behavior of the vehicle in the lateral direction and in the yaw direction of the vehicle, an operation amount related to steering of the vehicle will be changed with respect to either. Accordingly, due to results of computation of the operation amount related to the steering of the vehicle differing between the lateral direction and the yaw direction, there is a possibility that the position of the vehicle will not immediately return to the center position or the target position on the roadway. As a result, the behavior of the vehicle may exhibit behavior that is unexpected to an occupant thereof.

The disclosure has been made in view of the above technical problems, and an object of thereof is to provide a control device for an autonomous driving vehicle that is capable of suppressing the behavior of the vehicle from becoming behavior that is unexpected to the occupant, when assisting the vehicle to travel based on the behavior of the vehicle and an external situation of the vehicle.

In order to achieve the above object, in the disclosure,
a control device for an autonomous driving vehicle includes
a plurality of behavior detection sensors for detecting parameters relating to behavior of a vehicle, and
a plurality of external detection sensors for detecting objects that are present in surroundings of a roadway on which the vehicle is traveling.

The control device is configured to, based on map data stored in advance, a detection result of the behavior detection sensors, and a detection result of the external detection sensors, estimate a current position of the vehicle on the map data, compute a target path based on the current position of the vehicle on the map data that is estimated, and cause the vehicle to perform travel by autonomous driving based on the target path.

The control device includes a controller that estimates the current position on the map data and executes travel control of the vehicle based on control input set to cause the vehicle to perform the travel by autonomous driving along the target path.

The controller estimates the current position of the vehicle on the map data, by correcting a position of the vehicle on the map data in accordance with a relative position of the vehicle on the roadway that is found based on the detection result of the external detection sensors, calculates a correction amount of the position of the vehicle on the map data when the current position of the vehicle is estimated,
predicts, based on data related to a planned roadway that the vehicle is planned to travel on and that is detected by at least one of the map data and the external detection sensors, the correction amount on the planned roadway, and
changes a characteristic of the travel control when executing the travel control based on the control input, so as to change control gain in the control input in accordance with the correction amount and the correction amount that is predicted.

Also, in the disclosure,
the controller may be configured to change the characteristic of the travel control such that greater the correction amount and the predicted correction amount become, the greater the control gain becomes.

Also, in the disclosure,
the controller may be configured to calculate the correction amount for each of a longitudinal direction, a lateral direction, and a yaw direction of the vehicle, and
cause the vehicle to perform the travel by autonomous driving with the characteristic of the travel control changed such that a magnitude of the control gain is changed, based on the correction amount and the predicted correction amount for each of the longitudinal direction, the lateral direction, and the yaw direction.

Also, in the disclosure,
the controller may be configured to execute the travel control for causing the travel by autonomous driving, using a feedforward value set based on the planned roadway as the control input, and
when the characteristic of the travel control is changed, change the feedforward value based on the correction amount and the predicted correction amount.

Further, in the disclosure,
the controller may be configured to set the feedforward value based on a curvature of the target path on the planned roadway from the current position of the vehicle on the map data, calculate the control input for a steering angle of the vehicle based on the feedforward value, and
when correction in estimating the current position of the vehicle on the map data includes correction in a longitudinal direction of the vehicle at a time of changing the characteristic of the travel control, changes the feedforward value to an appropriate value based on the current position that is estimated.

According to the control device of the autonomous driving vehicle of the disclosure, the current position of the vehicle is estimated by correcting the position data of the vehicle, based on the map data and the behavior detection sensor of the vehicle, in accordance with the detection result of the external detection sensor of the vehicle, such as for example, the relative position of the vehicle based on a relative distance between the vehicle and a lane demarcation line. The vehicle is controlled to travel by autonomous driving in accordance with the current position of the vehicle that is estimated. When the vehicle is caused to travel by autonomous driving, a correction amount for correcting the position data in accordance with the relative position that is actually measured, and a predicted correction amount on the planned roadway based on the map data stored in advance and the external detection sensor, are computed. Further, the travel control for causing the vehicle to travel by autonomous driving is executed based on control input to a mechanism for causing the vehicle to travel. When the travel control is executed, the characteristic in the travel control for traveling by autonomous driving is changed so as to change the control gain in the travel control, based on the correction amount and the correction amount that is predicted. That is to say, the control input for causing the vehicle to travel by autonomous driving is changed in accordance with the correction amount of the position data and the change of the correction amount that is predicted. The control gain in the travel control of the vehicle is changed as described above, and accordingly decrease in tracking performance of the vehicle when the vehicle is caused to travel by autonomous driving based on the target path can be suppressed, and thus behavior that is unexpected to the occupant can be suppressed from occurring.

Also, a configuration is made in which the greater the correction amount and the predicted correction amount become, the greater the control gain in the travel control becomes to execute travel by autonomous driving. That is to say, the control gain is increased when the correction amount is great, and accordingly the occurrence of deviation of the position of the vehicle with respect to the center position or the target position on the roadway can be suppressed. Also, even when deviation of the position of the vehicle has occurred, the vehicle can be caused to travel by autonomous driving such that the deviation is quickly reduced. When the feedforward value is used for travel control, the feedforward value is changed in accordance with the correction amount. The feedforward value, which is set based on the curvature of the target path, is used to calculate the control input for the steering angle of the vehicle, and when there is correction in the longitudinal direction of the vehicle, the feedforward value is changed to an appropriate value based on the corrected position of the vehicle, i.e., the current position that is estimated. Thus, when the vehicle travels along the target path, the vehicle can be suppressed from deviating from the target path, or to quickly return the vehicle to the target path even when deviating. That is to say, the tracking performance of the vehicle with respect to the target path can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a vehicle equipped with a control device for an autonomous driving vehicle according to an embodiment of the disclosure;

FIG. 2 is a block diagram for explaining a functional configuration of a control device for an autonomous driving vehicle according to an embodiment of the disclosure;

FIG. 3 is a flowchart illustrating an example of control executed by a control device for an autonomous driving vehicle according to an embodiment of the disclosure;

FIG. 4 is an explanatory diagram for explaining position data on map data of a vehicle and a current position on map data of a vehicle; and

FIG. 5 is an explanatory diagram for explaining a case where the map data is different from the actual road.

### DETAILED DESCRIPTION OF EMBODIMENTS

Hereinafter, the disclosure will be described based on an embodiment shown in the drawings. Note that the embodiments described below are merely examples of a case where the disclosure is embodied, and are not intended to limit the disclosure.

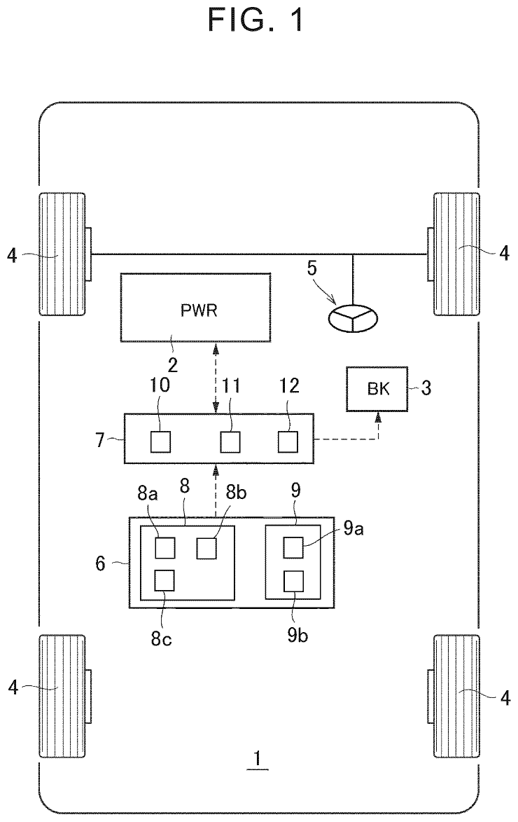

FIG. 1 is illustrating an autonomous driving vehicle (hereinafter, simply referred to as a vehicle) 1 on which a control device according to an embodiment of the present disclosure is mounted. The vehicle 1 according to the embodiment of the disclosure is a vehicle capable of not only traveling by manual operation but also autonomous driving by controlling a driving force, a braking force, a steering amount, and the like without the driver performing a driving operation. The vehicle 1 is also configured to be capable of recognizing a traveling environment, monitoring a surrounding situation, and the like based on the surrounding information externally acquired.

Autonomous driving of the vehicle 1 is executed on the basis of data related to the behavior of the vehicle 1 and data externally acquired. For example, the vehicle 1 acquires data related to the estimated or actually measured position of the vehicle 1, and controls the vehicle 1 by calculating an operation amount such as a driving force, a braking force, and a steering amount so that the vehicle 1 can travel along a predetermined target path based on data, map data, or the like related to the position of the vehicle 1, thereby performing autonomous driving. The vehicle 1 according to the embodiment of the disclosure is configured to accurately estimate the current position of the vehicle 1 serving as a reference when determining the operation amount of each device for changing the behavior of the vehicle 1, and to allow the vehicle 1 to travel by autonomous driving along a target path. It should be noted that the vehicle 1 may be any vehicle capable of traveling by autonomous driving, and may be a conventional vehicle such as an engine-driven vehicle, a hydrogen-powered vehicle, or a hybrid electric vehicle, fuel cell electric vehicle.

An exemplary embodiment of such a vehicle 1 is shown in FIG. 1. The vehicle 1 shown in FIG. 1 includes a driving force source 2, a brake device 3, wheels 4, a steering device 5, a detection unit 6, and an ECU (electronic control device) 7.

The driving force source 2 outputs torque for causing the vehicle 1 to travel. The driving force source 2 may include, for example, any of conventionally known engines (internal combustion engines) and motor generators, or any of them.

The brake device 3 is a device similar to a conventionally known brake device, and is provided, for example, in each of the front and rear wheels 4 of the vehicle 1. An example of the brake device 3 is a friction brake such as a disc brake, a drum brake, or a powder brake, and is configured to generate a braking force in a direction in which the rotation of each wheel 4 is stopped by generating a frictional force by hydraulic pressure, electromagnetic force, or the like.

The steering device 5 adjusts the traveling direction of the vehicle 1 by changing the azimuth angle. The steering device 5 is a device similar to a conventionally known steering device, and is, for example, a rack-and-pinion type electric power steering device provided with an electric assist mechanism.

The detection unit 6 is a device or a device for acquiring various kinds of data and information necessary for controlling the vehicle 1. The detection unit 6 includes an internal sensor 8 for acquiring data related to travel of the vehicle 1 itself, and an external sensor 9 for acquiring information outside the vehicle 1. The internal sensor 8 includes an acceleration sensor 8a for detecting an acceleration of the vehicle 1, a gyro sensor 8b for detecting a change in the attitude and orientation of the vehicle 1, for example, a yaw angle (azimuth angle) as an angular velocity, and a vehicle speed sensor 8c for detecting a vehicle speed from a rotational speed of a wheel. The external sensor 9 includes an in-vehicle camera 9a for acquiring captured images, a LiDAR 9b for acquiring information of an object based on data of reflected light of laser light, and the like. The internal sensor 8 corresponds to the behavior detection sensor in the embodiment of the disclosure, and the external sensor 9 corresponds to the external detection sensor in the embodiment of the disclosure.

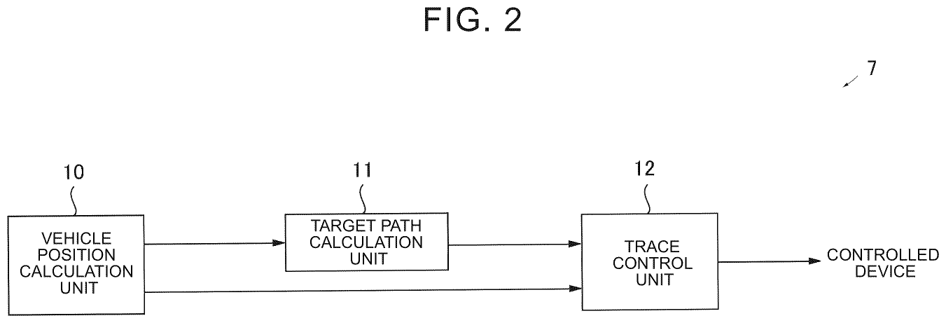

ECU 7 corresponds to a controller according to an embodiment of the present disclosure, and is mainly composed of a microcomputer including a processor (CPU), a storage device (RAM or ROM), an input/output device (input/output interface), and the like. ECU 7 is configured to perform an operation according to a predetermined program using various sensors 8 and 9 provided in the vehicle 1, data externally inputted, data stored in advance, and the like, and to output a result of the operation as a control command signal. For example, ECU 7 executes a function that matches a predetermined objective by the processor loading the program stored in the recording medium into a working area of the storage unit, executing the program, and performing various kinds of control through the execution of the program. ECU 7 also includes a vehicle-position estimation unit 10, a target path calculation unit 11, and a trace control unit 12 as shown in FIG. 1 and FIG. 2.

The vehicle position estimation unit 10 estimates a current position on the map data of the vehicle 1 based on a detection result such as a change in the behavior of the vehicle 1 and external information. The vehicle position estimation unit 10 detects and calculates a state quantity of the vehicle 1, for example, a vehicle speed, an acceleration, a yaw rate, and the like, based on the various sensors 8 and 9 described above. The vehicle position estimation unit 10 obtains the position data on the map data of the vehicle 1 based on the detected state quantity of the vehicle 1, an estimation result of the past vehicle position, stored map data, and the like. That is, on the map data, it is estimated which position of the road on which the vehicle 1 is currently traveling, and how much curvature or yaw rate the curved road is traveling on. Further, the vehicle position estimation unit 10 acquires the relative position of the vehicle 1 on the actual roadway on the basis of the in-vehicle camera 9a, LiDAR 9b, or the like that is the external sensor 9. For example, the vehicle position estimation unit 10 actually measures a relative position of a lane in which the vehicle 1 is traveling, a position in which the vehicle 1 is traveling in the traveling lane, and the like, based on a relative distance between the vehicle 1 and the lane demarcation line in the traveling lane recognized by the in-vehicle camera 9a, a vehicle surrounding the vehicle 1, a relative distance to a sign, and the like.

The vehicle position estimation unit 10 is configured to determine a difference between the relative position of the vehicle 1 actually measured in this way and the position of the vehicle 1 on the estimated map data. For example, when the vehicle 1 travels on a curved road, the estimated position of the vehicle 1 may travel along the center of the traveling lane on the map data, while the measured relative position of the vehicle 1 may travel toward a dividing line (for example, a lane center line) on the right side of the center of the traveling lane. In such a case, the vehicle position estimation unit 10 is configured to determine the correction amount of the position data when estimating the current position on the map data of the vehicle based on the difference between the position data of the vehicle 1 on the estimated map data and the actual position of the vehicle 1.

Further, the vehicle position estimation unit 10 calculates the difference between the estimated position data of the vehicle 1 and the actually measured position with respect to the respective components in the longitudinal direction (front-rear direction), the lateral direction (left-right direction), and the yaw direction of the vehicle 1. The vehicle position estimation unit 10 changes the parameters to be weighted for each component according to the characteristics of the components so that the position of the vehicle 1 can be appropriately estimated. For example, the vehicle position estimation unit 10 estimates the position of the yaw direction of the vehicle 1 by weighting the data based on the detection value of the internal sensor 8 provided in the vehicle 1. That is, the vehicle position estimation unit 10 mainly obtains the yaw angle of the vehicle 1 on the map data based on the behavior of the speed, acceleration, steering amount, and the like of the vehicle 1. Further, the vehicle position estimation unit 10 estimates the position on the map data by weighting the lateral direction of the vehicle 1 based on the data based on the position of the vehicle 1 actually measured by the external sensor 9. That is, the vehicle position estimation unit 10 is configured to estimate the position on the map data based on the behavior of the vehicle 1 in the lateral direction of the vehicle 1 in the same manner as the yaw direction, and to estimate the position by weighting the data based on the measured relative position of the vehicle 1. The vehicle position estimation unit 10 estimates the current position on the map data of the vehicle 1 by repeatedly executing the above-described calculation at predetermined intervals.

The target path calculation unit 11 calculates a target travel trajectory and a target curvature of the vehicle 1 based on the current position on the map data of the vehicle 1 obtained by the vehicle position estimation unit 10 and the information on the scheduled roadway that is the roadway on which the vehicle 1 is traveling or the roadway to be traveled. The information regarding the roadway is, for example, stored map data, lane demarcation lines on the roadway detected by the external sensor 9, signs, and other information such as vehicles. Based on the information, the target path calculation unit 11 calculates, on the map data, a target path or the like for the vehicle 1 to travel by autonomous driving comfortably for the occupant, such as such that the vehicle 1 travels at an appropriate speed in the center of the traveling lane, or such that the vehicle 1 enters at a curvature along the curvature of the curved road. In addition, when the current position on the map data of the vehicle 1 is different from the target path or the target curvature of the current vehicle 1, the target path calculation unit 11 obtains a trajectory such that the vehicle 1 can quickly return to such a target path or curvature. Note that a lane demarcation line, a sign, or another vehicle corresponds to an object present around the vehicle in the embodiment of the disclosure.

For example, the target path calculation unit 11 is configured to acquire the lane, the division line, the road boundary line information, and the like based on the map data, and calculate the target path based on the target position of the vehicle 1 based on the center line of the traveling lane. At that time, when it is detected that the current position on the map data of the vehicle 1 deviates from the target path, the target path calculation unit 11 obtains a travel trajectory such that the current position on the map data of the vehicle 1 gradually coincides with the position on the target path currently set. That is, the target path is obtained according to parameters such as the target position of the vehicle 1 with respect to the elapsed time from the current position on the map data of the vehicle 1, that is, the deviation amount in the longitudinal direction, the lateral direction, and the yaw direction from the current target path, the magnitude of the control input, the travel time of the vehicle 1, the allowable deviation amount, and the like, and the evaluation function and the constraint condition in the optimum control.

The trace control unit 12 is configured to execute travel control of the vehicle 1, and causes the vehicle 1 to travel by autonomous driving by combining feedback and feedforward based on data and the like acquired from the vehicle position estimation unit 10 and the target path calculation unit 11. That is, the trace control unit 12 calculates an operation amount and a control input of each device such as the driving force source 2, the brake device 3, and the steering device 5 that control the behavior of the driving force, the braking force, the steering amount, and the like of the vehicle 1. The trace control unit 12 acquires, from the vehicle position estimation unit 10, data on the correction amount of the position data on the map data based on the relative position or the actual measurement position of the vehicle 1 on the roadway with respect to each of the longitudinal direction, the lateral direction, and the yaw direction of the vehicle 1. Further, the trace control unit 12 acquires the target path, curvature, and the like of the vehicle 1 calculated by the target path calculation unit 11. Based on the acquired data, the trace control unit 12 calculates an operation amount and a control input of each device for controlling the behavior of the vehicle 1, which are necessary for the vehicle 1 to travel in accordance with a target path or curvature from the current position on the map data.

For example, when an operation amount related to the steering angle of the vehicle 1 is obtained based on the target path, the trace control unit 12 calculates the target steering angle and calculates the steering torque for obtaining the target steering angle. The target steering angle is calculated by using a target curvature, a target yaw angle, a target lateral deviation, and a control gain determined in advance for the parameters based on the shape of the target path. As an example, the target steering angle is obtained on the basis of a value obtained by multiplying each of a target curvature, a deviation between the target yaw angle and the actual yaw angle, a deviation between the target lateral deviation and the actual lateral deviation, and an integrated value of a deviation between the target lateral deviation and the actual lateral deviation by a control gain. The calculation of the target steering angle is performed every predetermined cycle, and the calculation is transmitted to ECU 7 every time, so that the steering mechanisms are controlled. In this way, each device that controls the behavior of the vehicle 1 is controlled based on the operation amount calculated by the trace control unit 12.

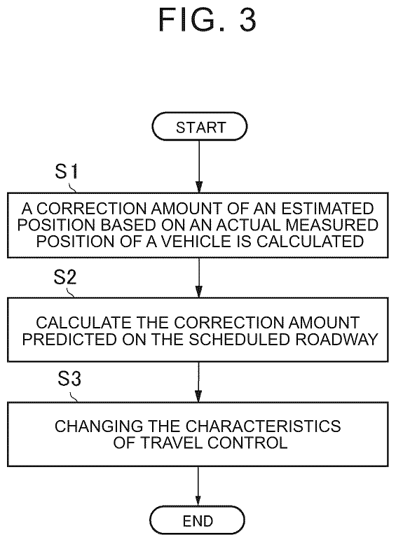

Next, an exemplary control executed by ECU 7 of the vehicle 1 configured as described above will be described. As shown in FIG. 3, in S1, a correction amount is calculated when the position data on the map data of the vehicle 1 is corrected based on the measured position on the roadway of the vehicle 1. In S1, as described above, when the position data on the map data of the vehicle 1 estimated mainly based on the state quantity of the vehicle 1 is deviated from the relative position of the vehicle 1 measured mainly based on the external sensor 9, the current position on the map data of the vehicle 1 is obtained by correcting the position data in accordance with the relative position. In S1, correction amounts are obtained for each of the longitudinal direction, the lateral direction, and the yaw direction of the vehicle 1 at that time.

After the correction amount of the position data of the vehicle 1 is obtained, the process proceeds to S2, and the correction amount of the predicted position data is calculated. In S2, a change such as an increase or a decrease in the correction amount is predicted on the basis of the traveling direction of the vehicle 1 and the shape of the scheduled roadway acquired from the data such as the map data and the external sensor 9. For example, in a case where the forward direction in the traveling direction is a straight road, it is predicted that the correction amount decreases. On the other hand, when the vehicle 1 is scheduled to travel on a temporary road due to a curved road ahead of the traveling direction, construction of a road surface, or the like, it is predicted that the deviation between the map data and the actual roadway becomes large. In such a case, it is predicted that the correction amount of the position data increases. In S2, a change in the correction amount is mainly predicted on the basis of the map data, the traveling direction acquired from the external sensor 9, and the road shape in the scheduled roadway.

After a change in the correction amount of the position data of the vehicle 1 is predicted, the process proceeds to S3, and the characteristic of the tracing control when the autonomous driving is executed is changed. In S3, the specific gravity of the parameter for determining the operating amount for causing the vehicle 1 to travel by autonomous driving is changed in accordance with the correction amount calculated in S1 and the correction amount predicted in S2 for the respective components in the longitudinal direction, the lateral direction, and the yaw direction of the vehicle 1. Specifically, in S3, in each of the above-described directions of the vehicle 1, as the correction amount and the predicted correction amount of the position data of the vehicle 1 on the map data based on the actual measurement position of the vehicle 1 on the roadway are larger, the control gain, that is, the feedback gain, for the deviation in each direction based on the corrected position data is larger. Further, if necessary, the feedforward value for calculating the control input for the steering angle of the vehicle 1 is controlled so as to be close to an appropriate value or a target value based on the roadway.

For example, when the correction amount of the position data of the vehicle 1 calculated in S1 is small and the predicted correction amount of the position data of the vehicle 1 is small in the lateral direction of the vehicle 1, a situation in which the position of the vehicle 1 deviates from the center position or the target position on the roadway hardly occurs. That is, when the correction amount is small, the difference between the position data or the estimated position of the vehicle 1 estimated based on the state quantity of the vehicle 1, the map data, and the like and the actual measured position of the vehicle 1 on the actual roadway measured by the external sensor 9 is small. That is, since the self-position of the vehicle 1 can be accurately estimated, as a result, a situation in which the position of the vehicle 1 deviates from the center position or the target position on the roadway is unlikely to occur. Therefore, the traveling characteristics in the trace control are not particularly changed. That is, the autonomous driving of the vehicle 1 is continued by the trace control while maintaining the current traveling characteristics.

On the other hand, in a case where the correction amount of the position data of the vehicle 1 is large and the predicted correction amount of the position data of the vehicle 1 is large in the lateral direction of the vehicle 1, the trace control of the vehicle is executed by increasing the feedback gain in the lateral direction of the vehicle 1. When both of the correction amount of the position data of the vehicle 1 and the predicted correction amount are large, the vehicle 1 is likely to be displaced from the center position or the target position on the roadway mainly in the lateral direction and the yaw direction of the vehicle 1. Therefore, the feedback gain is configured to be increased in advance in the lateral direction or the yaw direction.

In addition, in the case of correcting the vehicle 1 in the vertical direction, the operation amount is changed by changing the feedforward value set based on the curvature of the target path on the scheduled roadway from the current position of the vehicle 1 on the map data in addition to the correction by increasing the feedback gain. For example, when it is detected that the position data on the map data is behind the measured position on the roadway of the vehicle 1 when the vehicle 1 is placed on the curved road in the leftward direction, the position data of the vehicle 1 is corrected forward in the vertical direction and corrected to the right in the horizontal direction based on the relative position. As a result, the position data on the map data of the vehicle 1 is corrected to a position corresponding to the actual measurement position on the roadway of the vehicle, and the current position on the map data of the vehicle 1 is in a state of being rightward with respect to the roadway.

In such a case, in order to quickly move the vehicle 1 to a target position such as the center of the traveling lane, the curvature feedforward of the vehicle 1 is increased to the left turning side, and the feedback gain for the lateral deviation is increased. That is, by increasing the feedback gain, it is possible to quickly detect a deviation from the center position or the target position of the roadway of the vehicle 1, and to reflect the deviation in the operation amount of each device. Then, the position of the vehicle 1 on the map data is corrected forward, so that the feedforward value is changed to a value corresponding to the corrected current position of the vehicle 1. That is, by increasing the feedforward to the left turning side on the basis of the curvature of the target path on the roadway corresponding to the corrected current position of the vehicle 1, it is possible not to prevent the change in the operation amount due to such feedback control and to bring the feedforward value close to an appropriate value or a target value along the roadway. Therefore, the actual position of the vehicle 1 is controlled to return to the center position or the target position quickly.

As described above, in S3, as the correction amount of the estimated position of the vehicle 1 and the predicted correction amount increase in any direction of the longitudinal direction, the lateral direction, and the yaw direction, the characteristic of the trace control of the vehicle 1 is changed by increasing the feedback gain in any direction thereof. Further, the feedforward value is changed as necessary. The traveling by autonomous driving of the vehicle 1 is executed by controlling the driving force, the braking force, and the steering amount of the vehicle 1 based on the characteristics of the trace control thus changed. When the correction amount in the vertical direction and the predicted correction amount are large, there is a high possibility that a deviation occurs in the lateral direction and the yaw direction, and therefore, the feedback gain based on the deviation in each direction may be increased.

In the control device of the autonomous driving vehicle 1 configured as described above, the current position on the map data of the vehicle 1 is estimated based on the position data on the map data of the vehicle 1 estimated based on the behavior of the vehicle 1 and the actually measured position on the roadway of the vehicle 1 measured relatively by recognizing an object or the like around the vehicle 1. A target path to be traveled by the vehicle 1 is obtained on the basis of the current position of the vehicle 1 thus obtained, the map data, the lane demarcation line of the traveling lane detected by the external sensor 9, the road shape, and the like, and the vehicle 1 is controlled in accordance with an operation amount of the driving force source 2, the brake device 3, the steering device 5, and the like necessary for causing the vehicle 1 to travel by autonomous driving along the target path. At this time, when it is predicted that the difference between the position data on the map data of the vehicle 1 and the measured position on the roadway of the vehicle 1 increases, ECU 7 is configured to control the vehicle 1 by increasing the feedback gain. In addition, the feedforward value is configured to be close to an appropriate value as necessary.

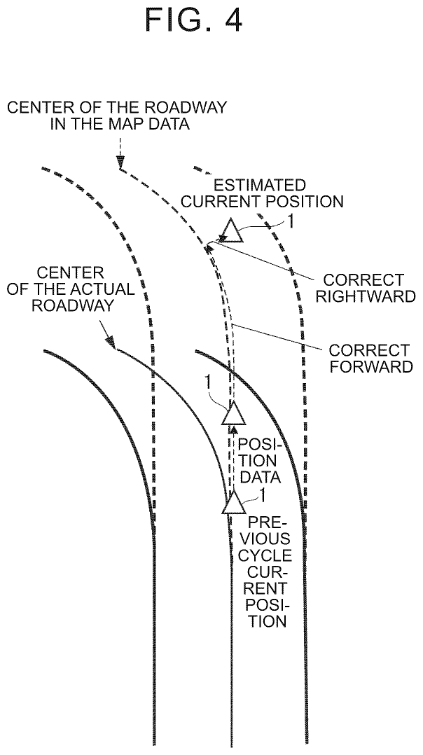

For example, when the vehicle 1 travels on a roadway curved to the left, the vehicle speed changes or the direction of the vehicle 1 changes toward the curved direction. As shown in FIG. 4, when the vehicle is caught on such a curved road, if the position data on the map data of the vehicle 1 is estimated to be located at the rear side with respect to the actual measured position on the roadway, that is, as shown by the vehicle 1 at the position of the position data, although the vehicle is traveling along the target path on the map data, it may be estimated at the rear side and the left side with respect to the actual roadway. In this case, the current position on the map data of the vehicle is obtained by correcting the position data of the vehicle 1 in the forward direction and the rightward direction in accordance with the distance from the object such as the lane demarcation line based on the external sensor 9. That is, the current position of the vehicle 1 on the map data is obtained based on the measured relative position of the vehicle 1. The current position on the map data of the vehicle 1 thus obtained is closer to the right side of the traveling lane. Therefore, the travel control of the vehicle 1 is controlled so as to increase the amount of turning in the leftward direction while bringing the vehicle 1 toward the center of the travel lane. Then, the driving force, the braking force, the steering angle, and the like of the vehicle 1 required for the vehicle 1 to travel back to the target path are calculated, and each device is controlled based on the calculation result.

At this time, in the embodiment of the disclosure, the traveling characteristic in the trace control of the vehicle 1 is changed. That is, as described above, the feedback gain is increased as the correction amount between the estimated position of the vehicle 1 and the measured position and the predicted correction amount increase. Also, at that time, the feedforward value is changed so as not to disturb the feedback or to approach the proper value or the target value. In the case of the above-described example, as the correction amount of the position data of the vehicle 1 based on the measured relative position of the vehicle 1 in the lateral direction increases, the feedback gain in the lateral direction in the travel control of the vehicle 1 increases. Then, the feedforward based on the curvature in the target path of the roadway is increased to the left turning side, that is, changed so as to approach an appropriate value with respect to the roadway. At this time, since the position of the yaw direction of the vehicle 1 is mainly determined based on a parameter corresponding to the behavior of the vehicle 1, there is a possibility that the correction amount is detected small. Therefore, ECU 7 is configured to continue the calculation of the feedback gain in the yaw direction without making any special change. That is, it is possible to control the behavior of the vehicle 1 such that the deviation between the center position and the target position on the roadway and the actual position of the vehicle 1 is rapidly reduced or such a deviation is suppressed.

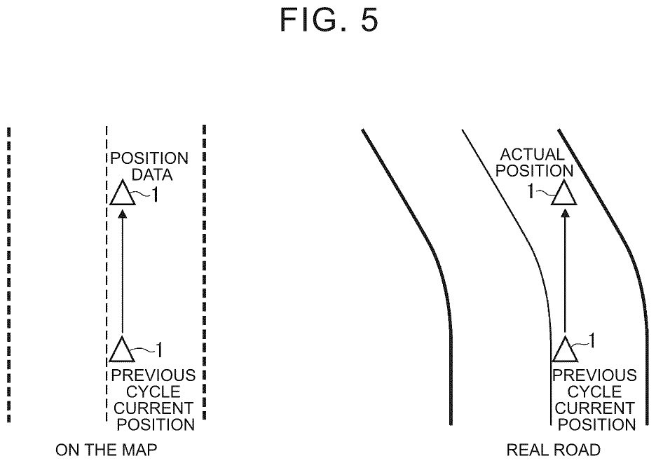

Further, as shown in FIG. 5, depending on the roadway, the map data may not accurately reflect the actual roadway due to the accuracy of the map data, the construction work, or the like. In such a case, there is a high possibility that the difference between the position data of the vehicle 1 described above and the measured position increases. As a result, there is a high possibility that the vehicle 1 travels at a position deviated from the center position or the target position of the roadway. Specifically, as shown in FIG. 5, there is a possibility that, on the map data (on the map), although the vehicle is traveling at the center position of the roadway, the vehicle gradually moves to the right side of the roadway on the actual roadway (on the actual road). On the other hand, in the above-described embodiment, the feedback gain is increased as the correction amount of the position data of the vehicle 1 with respect to the actual measured position and the predicted correction amount are increased, and the feedforward value is brought close to an appropriate value as necessary. Therefore, when a deviation occurs between the position data of the vehicle on the map data and the measured relative position of the vehicle, the operation amount of each device that controls the behavior of the vehicle 1 can be set so as to reduce the deviation.

Therefore, for example, even if the traveling position of the vehicle 1 deviates from the target path due to the difference between the position data of the vehicle 1 on the map data and the relative position of the vehicle 1 on the roadway, it is possible to suppress the occurrence of a sudden deceleration or a change in the steering amount in the vehicle 1 when the traveling position of the vehicle 1 is returned to the target path. That is, the traveling position of the vehicle 1 can be quickly returned to the target path. In addition, it is possible to suppress an unintended behavior of the occupant from occurring in the behavior of the vehicle 1.

Although the embodiments of the disclosure have been described above, the disclosure is not limited to the above-described examples, and may be appropriately modified within the scope of achieving the object of the disclosure. For example, for the autonomous driving of the vehicle 1 based on the trace control, an optimum control such as a model prediction control, which obtains and controls a control input for minimizing the evaluation function, may be used. In such a case, in the above-described control, when the correction amount of the estimated position based on the actual measured position of the vehicle 1 and the predicted correction amount become large, it is preferable that the trace control is executed by increasing the weighting to the parameter relating to the lateral deviation and the yaw angle deviation which are the trajectory following terms.

What is claimed is:

1. A control device for an autonomous driving vehicle, the control device comprising:
a plurality of behavior detection sensors for detecting parameters relating to behavior of a vehicle; and
a plurality of external detection sensors for detecting objects that are present in surroundings of a roadway on which the vehicle is traveling,
the control device being configured to, based on map data stored in advance, a detection result of the behavior detection sensors, and a detection result of the external detection sensors, estimate a current position of the vehicle on the map data, compute a target path based on the current position of the vehicle on the map data that is estimated, and cause the vehicle to perform travel by autonomous driving based on the target path, wherein:
the control device includes a controller that estimates the current position on the map data and executes travel control of the vehicle based on control input set to cause the vehicle to perform the travel by autonomous driving along the target path; and
the controller
estimates the current position of the vehicle on the map data, by correcting a position of the vehicle on the map data in accordance with a relative position of the vehicle on the roadway that is found based on the detection result of the external detection sensors,
calculates a correction amount of the position of the vehicle on the map data when the current position of the vehicle is estimated,
predicts, based on data related to a planned roadway that the vehicle is planned to travel on and that is detected by at least one of the map data and the external detection sensors, the correction amount on the planned roadway, and
changes a characteristic of the travel control when executing the travel control based on the control input, so as to change control gain in the control input in accordance with the correction amount and the correction amount that is predicted.

2. The control device according to claim 1, wherein the controller is configured to change the characteristic of the travel control such that greater the correction amount and the predicted correction amount become, the greater the control gain becomes.

3. The control device according to claim 1, wherein the controller is configured to
calculate the correction amount for each of a longitudinal direction, a lateral direction, and a yaw direction of the vehicle, and
cause the vehicle to perform the travel by autonomous driving with the characteristic of the travel control changed such that a magnitude of the control gain is changed, based on the correction amount and the predicted correction amount for each of the longitudinal direction, the lateral direction, and the yaw direction.

4. The control device according to claim 1, wherein the controller is configured to
execute the travel control for causing the travel by autonomous driving, using a feedforward value set based on the planned roadway as the control input, and
when the characteristic of the travel control is changed, change the feedforward value based on the correction amount and the predicted correction amount.

5. The control device according to claim 4, wherein the controller
sets the feedforward value based on a curvature of the target path on the planned roadway from the current position of the vehicle on the map data,
calculates the control input for a steering angle of the vehicle based on the feedforward value, and
when correction in estimating the current position of the vehicle on the map data includes correction in a longitudinal direction of the vehicle at a time of changing the characteristic of the travel control, changes the feedforward value to an appropriate value based on the current position that is estimated.
